(19) United States
(12) Patent Application Publication
(10) Pub. No.: US 2019/0033997 A1
(43) Pub. Date: Jan. 31, 2019

(54) INPUT CONTROL DEVICE, ELECTRONIC DEVICE, INPUT CONTROL METHOD, AND INPUT CONTROL PROGRAM

(71) Applicant: Alps Electric Co., Ltd., Tokyo (JP)

(72) Inventors: Kazuhito Oshita, Miyagi-ken (JP); Masaru Komatsu, Miyagi-ken (JP); Hiroshi Shigetaka, Miyagi-ken (JP); Koichi Miura, Miyagi-ken (JP); Tetsuo Muranaka, Miyagi-ken (JP); Naoyuki Hatano, Miyagi-ken (JP)

(21) Appl. No.: 16/046,412

(22) Filed: Jul. 26, 2018

(30) Foreign Application Priority Data
Jul. 28, 2017 (JP) 2017-147026

(51) Int. Cl. G06F 3/041

(52) U.S. Cl. CPC G06F 3/041

(57) ABSTRACT

An input control device includes a reception unit configured to receive a first input from a screen input device that detects an operation performed on an operation screen, and a second input from one or more other input devices, a setup unit configured to set, on a basis of the second input, decision criteria for deciding whether an operation performed on at least a part of a target region in the operation screen is valid, and a decision unit configured to decide whether the operation performed on at least a part of the target region is valid, on a basis of the first input and the decision criteria.

### CLAIM OF PRIORITY

This application claims benefit of priority to Japanese Patent Application No. 2017-147026 filed on Jul. 28, 2017, which is hereby incorporated by reference in its entirety.

### BACKGROUND

### 1. Field of the Disclosure

The present disclosure relates to an input control device that processes inputs from a screen input device and inputs from one or more other input devices, an electronic device including the input control device, an input control method for processing inputs from the screen input device and inputs from one or more other input devices, and an input control program for executing the input control method.

### 2. Description of the Related Art

Various types of input devices are incorporated in electronic devices such as a laptop computer. A keyboard and a screen input device are examples of the input device. The screen input device includes an operation screen, and detects an input action performed by an operating body that has contacted the operation screen. The operating body can be, for example, a finger or a dedicated pen. The input action can be represented by, for example, the position, locus, or velocity of a fingertip that has contacted the operation screen. The input action is detected, for example, as a variation in electrostatic capacitance between a plurality of electrodes located close to the operation screen.

The operation screen is often located at a position between the keyboard and the operator, and close to the input device other than the screen input device. Therefore, the operator may unintentionally touch the operation screen, while operating the input device such as the keyboard.

An input device according to Japanese Unexamined Patent Application Publication No. 2001-356869 is configured to inhibit an input through a touch pad, an example of the screen input device, upon detecting a key input through the keyboard. In the case where the key input is not performed for a predetermined time thereafter, the inhibition of the input through the touch pad is cancelled. Thus, the touch pad is prevented from being unintentionally operated, while inputs are being made through the keyboard.

An input device according to Japanese Unexamined Patent Application Publication No. 2011-138218 is configured, in addition to the mentioned function, to cancel the inhibition of the input, when a predetermined operation is performed on the touch pad while the input through the touch pad is inhibited.

With the input device according to the former document, however, since no input is accepted through the touch pad before the predetermined time elapses, the operator is unable to operate the touch pad immediately after operating the keyboard. The input device according to the latter document has to detect a special operation different from the normal input operation, and therefore the configuration of the input device becomes complicated. Further, the input device according to the latter document requires the operator to perform the special operation, thereby imposing an additional burden on the operator.

### SUMMARY

In one aspect, an input control device includes a reception unit configured to receive a first input from a screen input device that detects an operation performed on an operation screen, and a second input from one or more other input devices. A setup unit is configured to set, on a basis of the second input, decision criteria for deciding whether an operation performed on at least a part of a target region in the operation screen is valid. A decision unit is configured to decide whether the operation performed on at least a part of the target region is valid, on a basis of the first input and the decision criteria.

Such an input control device is configured to set the decision criteria according to the second input, and decide whether the operation performed on the operation screen is valid, on the basis of the first input and the decision criteria. Such a configuration facilitates the operation performed on the operation screen to be validated after the other input device is operated, unlike in the conventional devices that unconditionally invalidate the first input for a certain period after the second input is made. Therefore, unintended operation on the screen input device can be prevented, and the operation of the other input device can be easily and quickly shifted to the operation of the screen input device.

In another aspect, an electronic device includes a screen input device including an operation screen and configured to detect an operation performed on the operation screen, one or more other input devices, and an input control device. The input control device includes a reception unit configured to receive a first input from the screen input device and a second input from the one or more other input devices. A setup unit is configured to set, on a basis of the second input, decision criteria for deciding whether an operation performed on at least a part of a target region in the operation screen is valid. A decision unit is configured to decide whether the operation performed on at least a part of the target region is valid, on a basis of the first input and the decision criteria.

In still another aspect, an input control method includes receiving a first input from a screen input device that detects an operation performed on an operation screen and a second input from one or more other input devices, setting, on a basis of the second input, decision criteria for deciding whether an operation performed on at least a part of a target region in the operation screen is valid, and deciding whether the operation performed on at least a part of the target region is valid, on a basis of the first input and the decision criteria.

In still another aspect, an input control program is configured to cause a computer to execute the input control method.

### BRIEF DESCRIPTION OF THE DRAWINGS

FIG. 1 is a perspective view showing an electronic device according to an embodiment of the present invention;

FIG. 2 is a block diagram showing a configuration for controlling the electronic device shown in FIG. 1;

FIG. 3 is an exemplary and schematic graph representing a relation between a coordinate and variation in electrostatic capacitance, calculated by an input control device shown in FIG. 2;

FIG. 4 is a flowchart illustrating a validity decision method performed by the input control device shown in FIG. 2;

FIG. 5 is a flowchart illustrating a decision criteria selection method performed by the input control device shown in FIG. 2;

FIG. 6 is a flowchart illustrating a validity decision method according to a first variation;

FIG. 7 is a flowchart illustrating a validity decision method according to a second variation; and

FIG. 8 is a flowchart illustrating a validity decision method according to a third variation.

### DESCRIPTION OF THE EXEMPLARY EMBODIMENTS

General Configuration

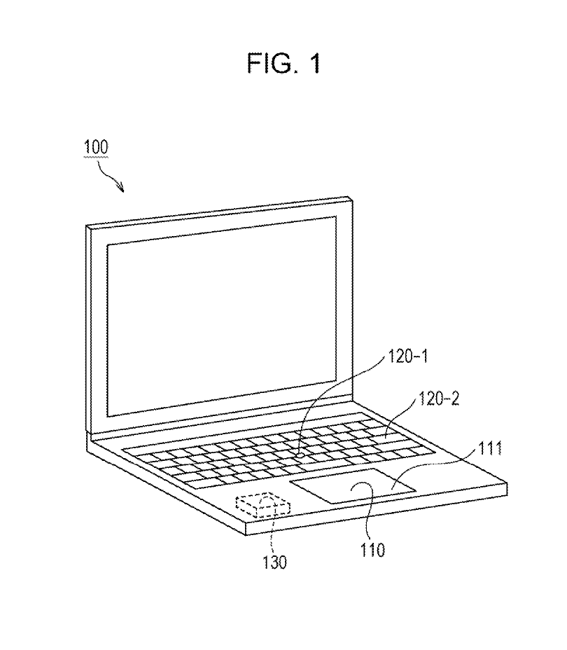

Hereafter, an electronic device 100 is disclosed according to an embodiment of the present invention. FIG. 1 is a perspective view showing the electronic device 100 according to the embodiment. The electronic device 100 may be a laptop computer, as an example. The electronic device 100 may also be a device of a different type, such as a desktop personal computer. The electronic device 100 includes a screen input device 110, a first other input device 120-1, a second other input device 120-2, and an input control device 130.

The screen input device 110 includes an operation screen 111, and detects an operation performed on the operation screen 111. The detection of the operation on the operation screen 111 includes detecting an operating body in direct contact with the operation screen 111, and also detecting the operating body that has come close enough to the operation screen 111 so as to be thereby detected. The operating body may be, for example, a finger or a dedicated pen. The screen input device 110 utilizes an electrostatic capacitance method, to detect the coordinate of the operating body on the basis of variation in electrostatic capacitance arising from the approach of the operating body.

The first other input device 120-1 detects a tilt direction of a pointing stick pressed by a fingertip, and magnitude of the pressing force applied thereby. The second other input device 120-2 is a keyboard for inputting characters. Hereinafter, the first other input device 120-1 and the second other input device 120-2 may be collectively referred to as other input devices 120, without distinction therebetween. The other input devices 120 are not limited to those cited above in the embodiment. The number of other input devices 120 may be other than two, not fewer than one.

The two other input devices 120 are located at positions farther from the operator, than the screen input device 110 is. Accordingly, the operator may unintentionally touch the screen input device 110, while operating one or both of the other input devices 120. For example, when the operator is operating the first other input device 120-1 with the fingers, or inputting characters through the second other input device 120-2, the palm may unintentionally touch the operation screen 111.

The input control device 130 is incorporated inside the electronic device 100, and controls the screen input device 110 and the two other input devices 120. For example, the input control device 130 detects the position on the operation screen 111 where the operating body has touched, as a coordinate. The input control device 130 also calculates variation in electrostatic capacitance at each coordinate on the operation screen 111. The operation of the input device based on the electrostatic capacitance is already known, and therefore the description will be omitted.

### Input Control Device

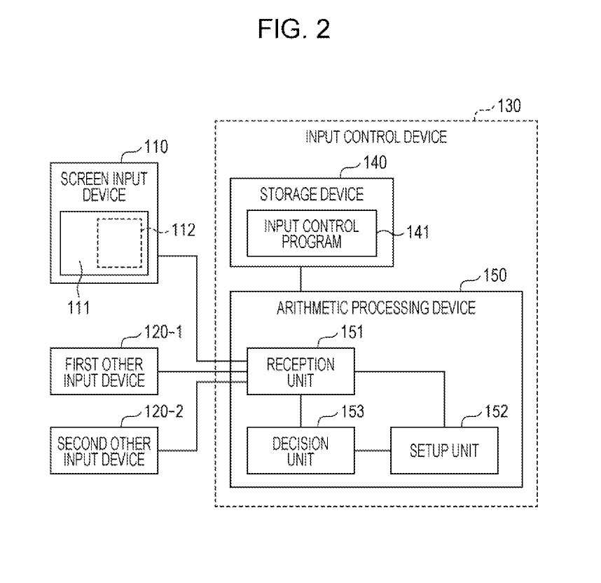

FIG. 2 is a block diagram showing a configuration for controlling the electronic device 100. The input control device 130 includes a storage device 140 and an arithmetic processing device 150.

The storage device 140 contains an input control program 141. The input control program 141 is retrieved by the arithmetic processing device 150, and implements the arithmetic processing device 150 with functions to execute a part of the input control method, as well as other functions. When the arithmetic processing device 150 executes the functions, the storage device 140 stores necessary information under the control of the arithmetic processing device 150. The storage device 140 is a non-transitory tangible storage medium. The storage device 140 may include a read-only memory (ROM) and a random-access memory (RAM). The storage device 140 may be a volatile or non-volatile storage medium. The storage device 140 may be either removable or unremovable.

The arithmetic processing device 150 retrieves and execute the input control program 141 stored in the storage device 140, to thereby act as a reception unit 151, a setup unit 152, and a decision unit 153. Although the arithmetic processing device 150 according to the embodiment is a general-purpose computer, the arithmetic processing device 150 may be an application-specific integrated circuits (ASIC), or other types of circuit capable of realizing the functions described in the embodiment.

The reception unit 151 receives a first input from the screen input device 110, and a second input from each of the two other input devices 120.

The setup unit 152 sets decision criteria for deciding whether an operation performed on a target region 112, which is at least a part of the operation screen 111, is valid, on the basis of the second input. The decision criteria is set so as to regard an operation as valid, when a size value corresponding to the dimensions of the operating body working on the operation screen 111 is within a valid range, and to regard the operation as invalid when the size value is outside of the valid range. The size value corresponds to the contact area between the operating body and the operation screen 111.

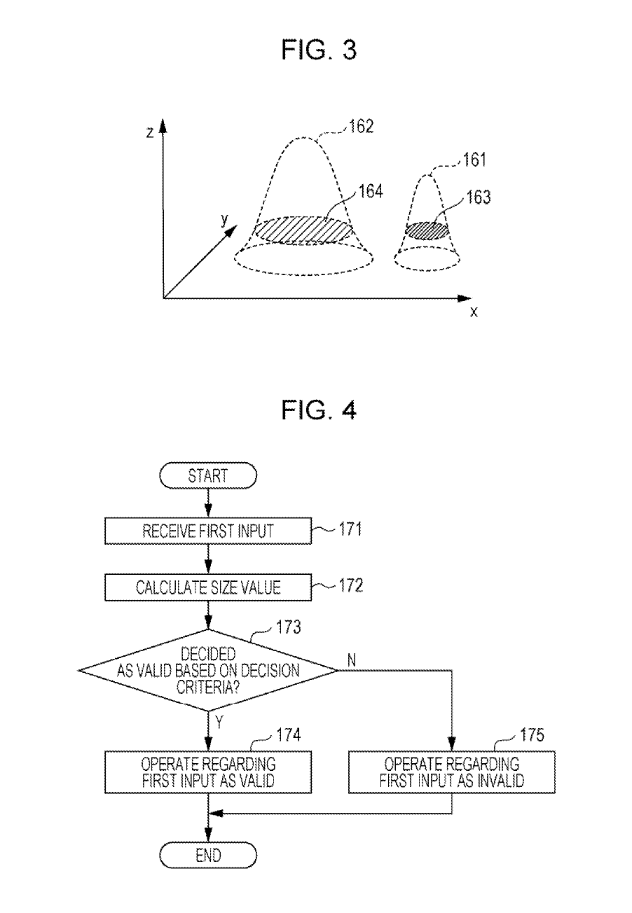

FIG. 3 is an exemplary and schematic graph representing a relation between a coordinate and variation in electrostatic capacitance, calculated by the input control device 130 on the basis of the first input from the screen input device 110. The x-axis and the y-axis represent a coordinate on a two-dimensional plane coinciding with the operation screen 111. The z-axis represents the variation in electrostatic capacitance at each coordinate on the operation screen 111. A graph 161 represents an exemplary variation in electrostatic capacitance generated when the fingertip touches the operation screen 111. A graph 162 represents an exemplary variation in electrostatic capacitance generated when the palm touches the operation screen 111.

In FIG. 3, the contact area of the operating body is defined as the area of a continuous region where the variation in electrostatic capacitance is equal to or larger than a threshold. The area of a first region 163 corresponds to the contact area of the fingertip. The area of a second region 164 corresponds to the contact area of the palm. In the embodiment, the contact area is used as the size value. In another example, the size value may be defined as the volume of a region equal to or larger than a threshold, in each of the graphs 161 and 162 in FIG. 3. Alternatively, the size value may be a different value, provided that the value represents the size of the operating body.

The target region 112 shown in FIG. 2 is identified by the coordinate on the operation screen 111. The target region 112 is at least a part of the entire region of the operation screen 111. In another example, the target region 112 may be the entire surface of the operation screen 111. Alternatively, a plurality of the target regions 112 may be provided. In this case, the decision criteria may be the same or different, with respect to each of the target regions 112.

The decision unit 153 decides whether an operation performed on the target region 112 is valid, on the basis of the first input and the decision criteria. As will be subsequently described, the operation is decided as invalid, for example, when the size value of the operating body corresponds to the size value of the palm, but decided as valid when the size value of the operating body corresponds to the size value of the fingertip. The distinction criterion between the palm and the fingertip varies depending on the decision criteria to be selected.

Input Control Method

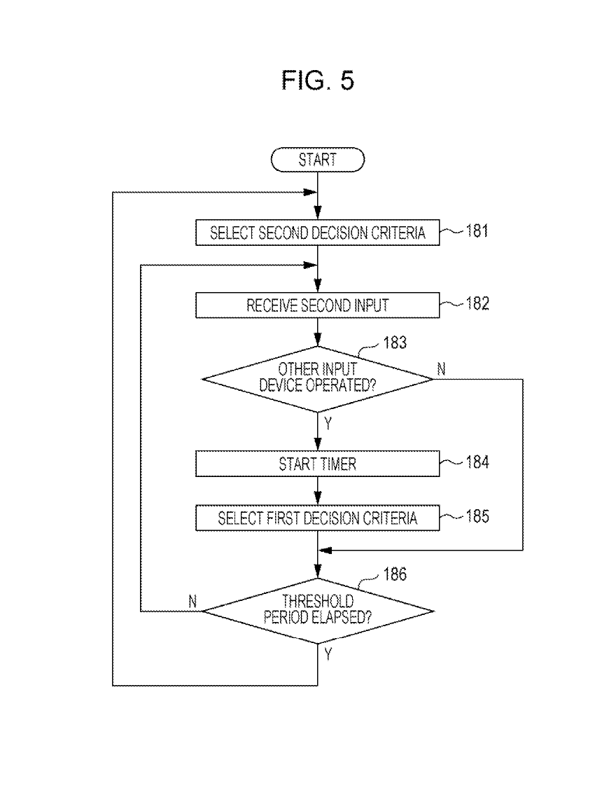

The input control device 130 shown in FIG. 2 executes the input control method. The input control method includes a validity decision method and a decision criteria selection method. FIG. 4 is a flowchart illustrating the validity decision method. FIG. 5 is a flowchart illustrating the decision criteria selection method.

### Validity Decision Method

First, the validity decision method will be described with reference to the flowchart shown in FIG. 4, and the components of the input control device 130 shown in FIG. 2. For the description of the validity decision method, it will be assumed that either decision criteria has already been selected.

At step 171 in FIG. 4, the decision unit 153 receives the first input through the reception unit 151. At step 172, the decision unit 153 calculates the size value of the operating body, on the basis of the first input. The size value represents the contact area, to be described with reference to FIG. 3.

At step 173 following step 172, the decision unit 153 decides whether an operation performed on the target region 112 is valid, on the basis of the size value calculated from the first input and the decision criteria. The decision criteria is set so as to regard the operation as valid, when the size value corresponding to the contact area is within the valid range, and to regard the operation as invalid when the size value is outside of the valid range.

As an example, the valid range is defined as a value between a lower limit and an upper limit. The valid range corresponds to a contact area, in the case where the operating body is a fingertip. In other words, an operation performed by an operating body having a size value assumed to be of a fingertip is decided to be valid. The lower limit of the valid range is, for example, larger than 0 but close thereto. The upper limit of the valid range corresponds to a boundary for distinction between the fingertip and a palm. Accordingly, in the case where the size value is beyond the upper limit of the valid range, it is assumed that the operating body is a palm, and therefore the operation is decided as invalid.

In the case where the operation is decided as valid at step 173, various processes are executed at step 174, on the premise that the first input is valid. For example, the input control device 130 detects the coordinate of the operating body on the basis of the first input made through the screen input device 110, and moves a cursor on the screen according to the movement of the operating body. Thus, when the operating body is assumed to be a fingertip, the input made by the operating body is properly processed.

In the case where the operation is not decided as valid at step 173, various processes are executed at step 175, on the premise that the first input is invalid. For example, the input control device 130 keeps the cursor unmoved, despite having detected the coordinate of the operating body on the basis of the first input made through the screen input device 110. Thus, when the operating body is assumed to be a palm, the input made by the operating body is ignored.

After step 174 or step 175, the validity decision process is finished. The input control device 130 repeatedly executes the validity decision process in a predetermined cycle, for example successively or randomly.

Decision Criteria Selection Method

Hereunder, the decision criteria selection method will be described with reference to the flowchart shown in FIG. 5 and the components of the input control device 130 shown in FIG. 2. As described below, the decision criteria includes a first decision criteria and a second decision criteria. The size value at the upper limit of the valid range according to the first decision criteria is smaller than the size value at the upper limit of the valid range according to the second decision criteria.

At step 181, the setup unit 152 selects the second decision criteria, to be used by the decision unit 153. Since the size value at the upper limit of the valid range according to the second decision criteria is larger than the size value at the upper limit of the valid range according to the first decision criteria, an operating body having a relatively large contact area is likely to be decided as valid.

At step 182 following step 181, the setup unit 152 receives a second input from each of the first other input device 120-1 and the second other input device 120-2, through the reception unit 151. Alternatively, the setup unit 152 may receive the second input from one of the two other input devices 120.

At step 183 following step 182, the setup unit 152 decides whether at least one of the two other input devices 120 have been operated. For example, when the pointing stick of the first other input device 120-1 is tilted, the other input device 120 is decided to have been operated. As another example, when a character is inputted through the second other input device 120-2, which is the keyboard, the other input device 120 is decided to have been operated.

In the case where it is decided at step 183 that the other input device 120 has been operated, the setup unit 152 starts a timer from 0 at step 184. When the timer is already working, the setup unit 152 resets the timer to 0. Thereafter, the timer automatically measures the elapsed time.

After step 184, the setup unit 152 selects the first decision criteria to be used by the decision unit 153, at step 185. Since the size value corresponding the upper limit of the valid range according to the first decision criteria is smaller than the size value at the upper limit of the valid range according to the second decision criteria first decision criteria, an operating body having a large contact area is less likely to be decided as valid. Thus, the range for the operating body to be assumed as the fingertip is narrower when the first decision criteria is selected, than when the second decision criteria is selected. This is based on the presumption that, immediately after the other input device 120 is operated, the palm is highly likely to unintentionally touch the screen input device 110.

In the case where it is not decided at step 183 that the other input device 120 has been operated, or after step 185, the setup unit 152 decides whether a threshold period has elapsed, according to the timer, at step 186. The threshold period corresponds to a period during which the first decision criteria remains selected, without one or more other input devices 120 being operated, after one or more other input devices 120 are operated and the first decision criteria is selected. In other words, the threshold period corresponds to a period until the first decision criteria is switched to the second decision criteria.

In the case where it is decided at step 186 that the threshold period has elapse, the setup unit 152 returns the operation to step 181. In other words, the second decision criteria is again selected as the decision criteria for use by the decision unit 153, when the threshold period has elapsed after the other input device 120 is operated last. This is based on the presumption that the palm is barely likely to touch the operation screen 111 when the other input device 120 is not being operated, and therefore an operation performed by a relatively large operating body on the operation screen 111 is decided as valid. Consequently, intended inputs can be exempted from being blocked.

In the case where it is not decided at step 186 that the threshold period has elapse, the setup unit 152 returns the operation to step 182. In other words, the first decision criteria remains selected for use by the decision unit 153, during the threshold period after the other input device 120 is operated last.

Conclusion

The input control device 130 according to the embodiment includes the reception unit 151 configured to receive the first input from the screen input device 110 that detects an operation performed on the operation screen 111, and the second input from one or more other input devices 120, the setup unit 152 configured to set, on the basis of the second input, the decision criteria for deciding whether an operation performed on at least a part of the target region 112 in the operation screen 111 is valid, and the decision unit 153 configured to decide whether the operation performed on at least a part of the target region 112 is valid, on the basis of the first input and the decision criteria.

The input control device 130 is configured to set the decision criteria according to the second input, and decide whether the operation performed on the operation screen 111 is valid, on the basis of the first input and the decision criteria. Such a configuration facilitates the operation performed on the operation screen 111 to be validated after the other input device 120 is operated, unlike in the conventional devices that unconditionally invalidate the first input for a certain period after the second input is made. Therefore, unintended operation on the screen input device 110 can be prevented, and also the operation of the other input device 120 can be easily and quickly shifted to the operation of the screen input device 110.

The decision criteria is set so as to regard an operation as valid, when the size value corresponding to the dimensions of the operating body working on the operation screen 111 is within the valid range, and to regard the operation as invalid when the size value is outside of the valid range.

As mentioned above, the validity of the operation is determined on the basis of the size value corresponding to the dimensions of the operating body, for example the palm or the fingertip. Such an arrangement facilitates the operation performed on the operation screen 111 after the operation is performed on the other input device 120 to be properly validated, from the viewpoint that the size value of the operating body working on the operation screen 111, and the size value of the operating body that has touched the operation screen 111 while the other input device is being operated, are different from each other.

The setup unit 152 selects the first decision criteria for the threshold period, after one or more other input devices 120 are operated, and selects the second decision criteria when the threshold period has elapsed without the one or more other input devices 120 having been operated.

As mentioned above, the decision criteria is changed depending on whether the threshold period has elapsed, instead of unconditionally invalidating the first input, and therefore the operation of the other input device 120 can be easily and quickly shifted to the operation of the screen input device 110, compared with the case of unconditionally invalidating the first input.

The size value at the upper limit of the valid range of the first decision criteria is smaller than the size value at an upper limit of the valid range of the second decision criteria.

Accordingly, when the first decision criteria is selected, the operating body is ignored unless the size value of the operating body is smaller, compared with when the second decision criteria is selected. Therefore, the screen input device 110 can be prevented from being unintentionally operated with higher accuracy, from the viewpoint that the contact made by the operating body on the operation screen 111, within the threshold period after one or more other input devices 120 are operated, is most probably made unintentionally.

The size value corresponds to the contact area between the operating body and the operation screen 111.

Accordingly, the validity of the operation is determined on the basis of the size value corresponding to the dimensions of the operating body, for example the palm or the fingertip. The mentioned arrangement facilitates the operation performed on the operation screen 111 after the operation is performed on the other input device 120 to be properly validated, from the viewpoint that the contact area created by the operating body working on the operation screen 111, and the contact area created by the operating body that has touched the operation screen 111 while the other input device 120 is being operated, are different from each other.

The present invention is not limited to the foregoing embodiment. Persons skilled in the art may make various modifications, combinations, sub combinations, or substitution of the embodiment, within the technical scope of the present invention and the equivalents thereof.

First Variation

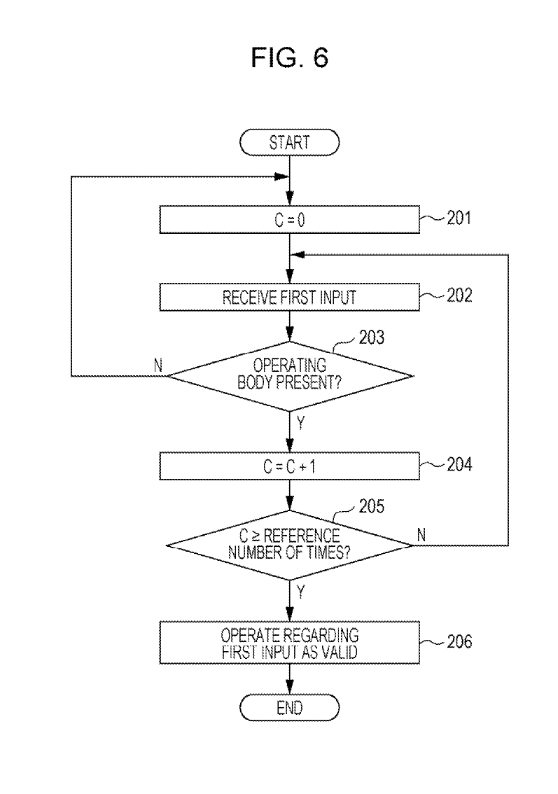

Hereunder, a first variation of the validity decision method and the decision criteria selection method will be described. FIG. 6 is a flowchart illustrating the validity decision method according to the first variation. The following description primarily focuses on differences between the validity decision method and the decision criteria selection method according to the embodiment, described with reference to FIG. 4 and FIG. 5, and the validity decision method and the decision criteria selection method according to the first variation.

First, the validity decision method according to the first variation will be described. For the description of the validity decision method according to the first variation, it will be assumed that one of the decision criteria has already been selected. The decision criteria according to the first variation is set so as to regard an operation as valid, when the operating body is detected on the operation screen 111 equal to or more than a reference number of times consecutively.

At step 201 shown in FIG. 6, the decision unit 153 initializes a count C as C=0. The count C represents the number of times that the operating body has been consecutively detected. At step 202, the decision unit 153 receives the first input, through the reception unit 151.

At step 203, the decision unit 153 decides whether an operating body working on the operation screen 111 is present, on the basis of the first input. As an example, the decision unit 153 decides that an operating body is present, when an operating body having an area equal to or larger than a predetermined area is detected on the operation screen 111.

In the case where it is decided at step 203 that the operating body is not present, the operation returns to step 201. In the case where it is decided at step 203 that the operating body is present, the decision unit 153 adds 1 to the count C, at step 204. At step 205 following step 204, the decision unit 153 decides whether the count C is equal to or larger than the predetermined reference number of times.

In the case where it is decided at step 205 that the count C is fewer than the predetermined reference number of times, the operation returns to step 202. In the case where it is decided at step 205 that the count C is equal to or larger than the predetermined reference number of times, various processes are executed at step 206, on the premise that the first input is valid. For example, the input control device 130 detects the coordinate of the operating body on the basis of the first input made through the screen input device 110, and moves the cursor on the screen according to the movement of the operating body.

Before it is decided that the operation is valid, the processes are executed on the premise that the first input is invalid. For example, the input control device 130 keeps the cursor unmoved, despite having detected the coordinate of the operating body on the basis of the first input made through the screen input device 110.

After step 206, the validity decision process is finished. The input control device 130 repeatedly executes the validity decision process in a predetermined cycle, for example successively or randomly.

By the decision criteria selection method according to the first variation, the first decision criteria and the second decision criteria are selected, as the decision criteria selection method according to the embodiment described with reference to FIG. 5. However, the decision criteria according to the first variation is set so as to regard the operation as valid, when the operating body is detected on the operation screen 111, equal to or more than the reference number of times consecutively. The increase in count C corresponds to the lapse of time. In the embodiment, the count C increases at generally regular time intervals. In another example, the count C does not increase at regular time intervals.

The reference number of times according to the first decision criteria is larger than the reference number of times according to the second decision criteria. Therefore, when the first decision criteria is selected, an operation of a small contact duration is barely likely to be decided as valid. This is based on the presumption that, immediately after the other input device 120 is operated, the hand is highly likely to temporarily touch the operation screen 111 unintentionally.

When the threshold period has elapsed after the other input device 120 is operated last, the decision criteria to be used by the decision unit 153 is switched to the second decision criteria. This is based on the presumption that the hand is barely likely to temporarily touch the operation screen 111 unintentionally, when the other input device 120 is not being operated, and therefore an operation performed for a relatively short period is decided as valid. Consequently, intended inputs can be exempted from being blocked.

Conclusion

In the input control device 130, the decision criteria is set so as to regard the operation as valid, when the operating body has been detected on the operation screen 111 equal to or more than the reference number of times consecutively, and the reference number of times according to the first decision criteria is larger than the reference number of times according to the second decision criteria.

Accordingly, when the first decision criteria is selected, the operation is not validated unless the operating body is detected a larger number of times, compared with when the second decision criteria is selected. Therefore, the screen input device 110 can be prevented from being unintentionally operated with higher accuracy, from the viewpoint that the contact made by the operating body with the operation screen 111, within the threshold period after one or more other input devices 120 are operated, is most probably made unintentionally.

Second Variation

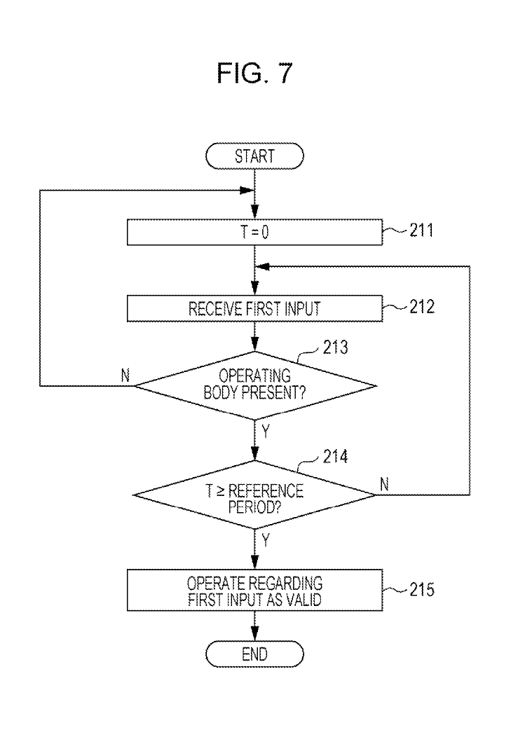

Hereunder, a second variation of the validity decision method and the decision criteria selection method will be described. FIG. 7 is a flowchart illustrating the validity decision method according to the second variation. The following description primarily focuses on differences between the validity decision method and the decision criteria selection method according to the embodiment, described with reference to FIG. 4 and FIG. 5, and the validity decision method and the decision criteria selection method according to the second variation.

First, the validity decision method according to the second variation will be described. For the description of the validity decision method according to the second variation, it will be assumed that one of the decision criteria has already been selected. The decision criteria according to the second variation is set so as to regard an operation as valid, when the operating body is continuously detected on the operation screen 111, equal to or longer than a reference period.

At step 211 shown in FIG. 7, the decision unit 153 initializes a timer T as T=0. The timer T represents the period during which the operating body has been continuously detected. At step 212, the decision unit 153 receives the first input through the reception unit 151.

At step 213, the decision unit 153 decides whether an operating body working on the operation screen 111 is present, on the basis of the first input. As an example, the decision unit 153 decides that an operating body is present, when an operating body having an area equal to or larger than a predetermined area is detected on the operation screen 111.

In the case where it is decided at step 213 that the operating body is not present, the operation returns to step 211. In the case where it is decided at step 213 that the operating body is present, the decision unit 153 decides whether the timer T is indicating a period equal to or longer than the predetermined reference period, at step 214.

In the case where it is decided at step 214 that the timer T is not indicating a period equal to or longer than the predetermined reference period, the operation returns to step 212. In the case where it is decided at step 214 that the timer T is indicating a period equal to or longer than the predetermined reference period, various processes are executed at step 215, on the premise that the first input is valid. For example, the input control device 130 detects the coordinate of the operating body on the basis of the first input made through the screen input device 110, and moves the cursor on the screen according to the movement of the operating body.

Before it is decided that the operation is valid, the processes are executed on the premise that the first input is invalid. For example, the input control device 130 keeps the cursor unmoved, despite having detected the coordinate of the operating body on the basis of the first input made through the screen input device 110.

After step 215, the validity decision process is finished. The input control device 130 repeatedly executes the validity decision process in a predetermined cycle, for example successively or randomly.

By the decision criteria selection method according to the second variation, the first decision criteria and the second decision criteria are selected, as the decision criteria selection method according to the embodiment described with reference to FIG. 5. However, the decision criteria according to the second variation is set so as to regard the operation as valid, when the operating body is continuously detected on the operation screen 111, equal to or longer than a reference period. The reference period according to the first decision criteria is longer than the reference period according to the second decision criteria. Therefore, when the first decision criteria is selected, an operation of a short contact duration is barely likely to be decided as valid. This is based on the presumption that, immediately after the other input device 120 is operated, the hand is highly likely to temporarily touch the operation screen 111 unintentionally.

When the threshold period has elapsed after the other input device 120 is operated last, the decision criteria to be used by the decision unit 153 is switched to the second decision criteria. This is based on the presumption that the hand is barely likely to temporarily touch the operation screen 111 unintentionally, when the other input device 120 is not being operated, and therefore an operation performed for a relatively short period is decided as valid. Consequently, intended inputs can be exempted from being blocked.

Conclusion

In the input control device 130, the decision criteria is set so as to regard the operation as valid, when the operating body has been continuously detected on the operation screen 111 equal to or longer than the reference period, and the reference period according to the first decision criteria is longer than the reference period according to the second decision criteria.

Accordingly, when the first decision criteria is selected, the operation is not validated unless the operating body is detected for a longer period, compared with when the second decision criteria is selected. Therefore, the screen input device 110 can be prevented from being unintentionally operated with higher accuracy, from the viewpoint that the contact made by the operating body on the operation screen 111, within the threshold period after one or more other input devices 120 are operated, is most probably made unintentionally.

Third Variation

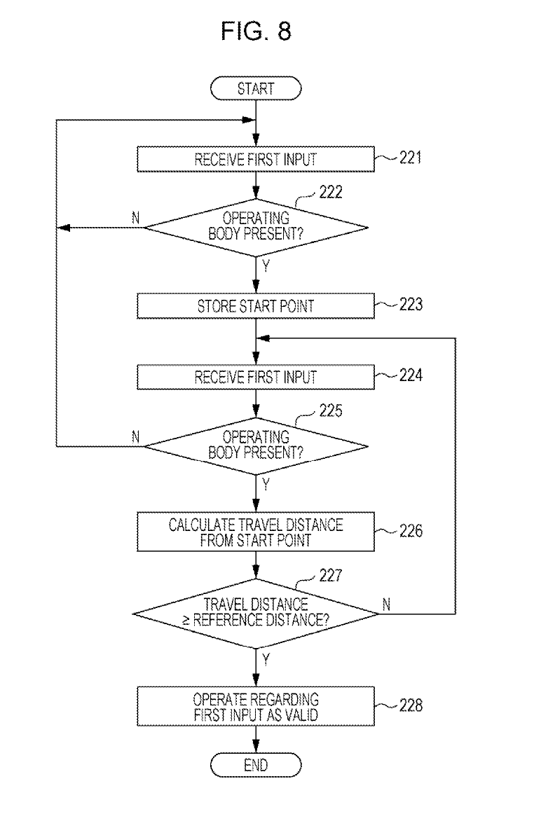

Hereunder, a third variation of the validity decision method and the decision criteria selection method will be described. FIG. 8 is a flowchart illustrating the validity decision method according to the third variation. The following description primarily focuses on differences between the validity decision method and the decision criteria selection method according to the embodiment, described with reference to FIG. 4 and FIG. 5, and the validity decision method and the decision criteria selection method according to the third variation.

First, the validity decision method according to the third variation will be described. For the description of the validity decision method according to the third variation, it will be assumed that one of the decision criteria has already been selected. The decision criteria according to the second variation is set so as to regard an operation as valid, when the operating body is detected to have moved on the operation screen 111, equal to or longer than a reference distance.

At step 221 shown in FIG. 8, the decision unit 153 receives the first input through the reception unit 151. At step 222, the decision unit 153 decides whether an operating body working on the operation screen 111 is present, on the basis of the first input. As an example, the decision unit 153 decides that an operating body is present, when an operating body having an area equal to or larger than a predetermined area is detected on the operation screen 111. In the case where it is decided at step 222 that the operating body is not present, the operation returns to step 221.

In the case where it is decided at step 222 that the operating body is present, the decision unit 153 stores the current coordinate of the operating body as a start point, at step 223. At step 224 following step 223, the decision unit 153 receives the first input through the reception unit 151. At step 225 following step 224, the decision unit 153 decides whether an operating body working on the operation screen 111 is present, on the basis of the first input. In the case where it is decided at step 225 that the operating body is not present, the operation returns to step 221.

In the case where it is decided at step 225 that the operating body is present, the decision unit 153 calculates, at step 226, the travel distance of the operating body from the start point. At step 227 following step 226, the decision unit 153 decides whether the travel distance is equal to or longer than the predetermined reference distance.

In the case where it is decided at step 227 that travel distance is not equal to or longer than the predetermined reference distance, the operation returns to step 224. In the case where it is decided at step 227 that travel distance is equal to or longer than the predetermined reference distance, various processes are executed at step 228, on the premise that the first input is valid. For example, the input control device 130 detects the coordinate of the operating body on the basis of the first input made through the screen input device 110, and moves the cursor on the screen according to the movement of the operating body.

Before it is decided that the operation is valid, the processes are executed on the premise that the first input is invalid. For example, the input control device 130 keeps the cursor unmoved, despite having detected the coordinate of the operating body on the basis of the first input made through the screen input device 110.

After step 228, the validity decision process is finished. The input control device 130 repeatedly executes the validity decision process in a predetermined cycle, for example successively or randomly.

By the decision criteria selection method according to the third variation, the first decision criteria and the second decision criteria are selected, as the decision criteria selection method according to the embodiment described with reference to FIG. 5. However, the decision criteria according to the third variation is set so as to regard the operation as valid, when the operating body is detected to have moved on the operation screen 111, equal to or longer than the reference distance.

The reference distance according to the first decision criteria is longer than the reference distance according to the second decision criteria. Therefore, when the first decision criteria is selected, an operation performed over a short distance is barely likely to be decided as valid. This is based on the presumption that, immediately after the other input device 120 is operated, the hand is highly likely to temporarily touch the operation screen 111 unintentionally.

When the threshold period has elapsed after the other input device 120 is operated last, the decision criteria to be used by the decision unit 153 is switched to the second decision criteria. This is based on the presumption that the hand is barely likely to temporarily touch the operation screen 111 unintentionally, when the other input device 120 is not being operated, and therefore an operation performed for a relatively short period is decided as valid. Consequently, intended inputs can be exempted from being blocked.

Conclusion

In the input control device 130, the decision criteria is set so as to regard the operation as valid, when the operating body has been detected to have moved on the operation screen 111 equal to or longer than the reference distance, and the reference distance according to the first decision criteria is longer than the reference distance according to the second decision criteria.

Accordingly, when the first decision criteria is selected, the operation is not validated unless the operating body has moved a longer distance, compared with when the second decision criteria is selected. Therefore, the screen input device 110 can be prevented from being unintentionally operated with higher accuracy, from the viewpoint that the contact made by the operating body with the operation screen 111, within the threshold period after one or more other input devices are operated, is most probably made unintentionally.

What is claimed is:

1. An input control device comprising:
a reception unit configured to receive a first input from a screen input device that detects an operation performed on an operation screen, and a second input from one or more other input devices;
a setup unit configured to set, on a basis of the second input, decision criteria for deciding whether an operation performed on at least a part of a target region in the operation screen is valid; and
a decision unit configured to decide whether the operation performed on at least a part of the target region is valid, on a basis of the first input and the decision criteria.

2. The input control device according to claim 1,
wherein the decision criteria is set to regard an operation as valid, when a size value corresponding to dimensions of an operating body working on the operation screen is within a valid range, and to regard the operation as invalid when the size value is outside of the valid range.

3. The input control device according to claim 2,
wherein the setup unit selects:
a first decision criteria for a threshold period, after the one or more other input devices are operated; and
a second decision criteria when the threshold period has elapsed without the one or more other input devices having been operated, and
the size value at an upper limit of the valid range of the first decision criteria is smaller than the size value at an upper limit of the valid range of the second decision criteria.

4. The input control device according to claim 2,
wherein the size value corresponds to a contact area between the operating body and the operation screen.

5. The input control device according to claim 1,
wherein the setup unit selects:
a first decision criteria for a threshold period, after the one or more other input devices are operated; and
a second decision criteria different from the first decision criteria, when the threshold period has elapsed without the one or more other input devices having been operated.

6. The input control device according to claim 5,
wherein the decision criteria is set to regard an operation as valid, when an operating body has been detected on the operation screen equal to or more than a reference number of times consecutively, and
the reference number of times according to the first decision criteria is larger than the reference number of times according to the second decision criteria.

7. The input control device according to claim 5,
wherein the decision criteria is set to regard the operation as valid, when the operating body has been detected on the operation screen equal to or longer than a reference period, and
the reference period according to the first decision criteria is longer than the reference period according to the second decision criteria.

8. The input control device according to claim 5,
wherein the decision criteria is set to regard the operation as valid, when the operating body has been detected to have moved on the operation screen equal to or longer than a reference distance, and
the reference distance according to the first decision criteria is longer than the reference distance according to the second decision criteria.

9. An electronic device comprising:
a screen input device including an operation screen and configured to detect an operation performed on the operation screen;
one or more other input devices; and
an input control device,
wherein the input control device includes:
a reception unit configured to receive a first input from the screen input device and a second input from the one or more other input devices;
a setup unit configured to set, on a basis of the second input, decision criteria for deciding whether an operation performed on at least a part of a target region in the operation screen is valid; and
a decision unit configured to decide whether the operation performed on at least a part of the target region is valid, on a basis of the first input and the decision criteria.

10. An input control method comprising:
receiving a first input from a screen input device that detects an operation performed on an operation screen and a second input from one or more other input devices;
setting, on a basis of the second input, decision criteria for deciding whether an operation performed on at least a part of a target region in the operation screen is valid; and
deciding whether the operation performed on at least a part of the target region is valid, on a basis of the first input and the decision criteria.

11. An nonvolatile storage medium having stored therein an input control program, the input control program when executed on a computer configured to cause the computer to:
receive a first input from a screen input device that detects an operation performed on an operation screen and a second input from one or more other input devices;
set, on a basis of the second input, decision criteria for deciding whether an operation performed on at least a part of a target region in the operation screen is valid; and
decide whether the operation performed on at least a part of the target region is valid, on a basis of the first input and the decision criteria.

12. An input control device comprising:
At least one processor and a nonvolatile memory having stored therein an input control program such that when the at least one processor executes the input control program the at least one processor:
receives a first input from a screen input device that detects an operation performed on an operation screen, and a second input from one or more other input devices;
sets, on a basis of the second input, decision criteria for deciding whether an operation performed on at least a part of a target region in the operation screen is valid; and
decides whether the operation performed on at least a part of the target region is valid, on a basis of the first input and the decision criteria.

13. The input control device according to claim 12,
wherein the decision criteria is set to regard an operation as valid, when a size value corresponding to dimensions of an operating body working on the operation screen is within a valid range, and to regard the operation as invalid when the size value is outside of the valid range.

14. The input control device according to claim 13,
wherein the at least one processor selects:
a first decision criteria for a threshold period, after the one or more other input devices are operated; and
a second decision criteria when the threshold period has elapsed without the one or more other input devices having been operated, and
the size value at an upper limit of the valid range of the first decision criteria is smaller than the size value at an upper limit of the valid range of the second decision criteria.

15. The input control device according to claim 13,
wherein the size value corresponds to a contact area between the operating body and the operation screen.

16. The input control device according to claim 12,
wherein the at least one processor selects:
a first decision criteria for a threshold period, after the one or more other input devices are operated; and
a second decision criteria different from the first decision criteria, when the threshold period has elapsed without the one or more other input devices having been operated.

17. The input control device according to claim 16,
wherein the decision criteria is set to regard an operation as valid, when an operating body has been detected on the operation screen equal to or more than a reference number of times consecutively, and
the reference number of times according to the first decision criteria is larger than the reference number of times according to the second decision criteria.

18. The input control device according to claim 16,
wherein the decision criteria is set to regard the operation as valid, when the operating body has been detected on the operation screen equal to or longer than a reference period, and
the reference period according to the first decision criteria is longer than the reference period according to the second decision criteria.

19. The input control device according to claim 16,
wherein the decision criteria is set to regard the operation as valid, when the operating body has been detected to have moved on the operation screen equal to or longer than a reference distance, and
the reference distance according to the first decision criteria is longer than the reference distance according to the second decision criteria.
